(19) United States
(12) Patent Application Publication
(10) Pub. No.: US 2012/0124746 A1
(43) Pub. Date: May 24, 2012

(54) PATIENT SUPPORT APPARATUS WITH EGRESS UNITS

(76) Inventors: Kirill Andrienko, Harrison, OH (US); Robert Mark Zerhusen, Cincinnati, OH (US); Richard H. Heimbrock, Cincinnati, OH (US)

(21) Appl. No.: 12/951,375

(22) Filed: Nov. 22, 2010

(51) Int. Cl. A61G 7/16; A61G 7/015

(52) U.S. Cl. 5/618

(57) ABSTRACT

A patient support apparatus includes a base, a frame coupled to the base, and a deck supported by the frame and capable of moving relative to the frame. The patient support apparatus further includes a utility apparatus coupled to the deck and configurable to assume one of a storage mode and a use mode.

### BACKGROUND

The present disclosure is related to a support apparatus for supporting a patient. More particularly, the present disclosure relates to a bed that can be manipulated to achieve both a conventional bed position having a horizontal support surface and a chair position having the feet of the patient on or adjacent to the floor and the head and back of the patient supported above a seat formed by the bed.

It is known to provide beds that have a head siderail assembly coupled to a head portion of the support surface and a foot siderail assembly coupled to a seat portion of the support surface. The siderail assemblies may be movable independently of one another between a raised position and a lowered position. The siderail assemblies may be used in the raised position to retain patients resting on the support surface and in the lowered position to transfer patients from the bed to another support apparatus, allow a caregiver improved access to the patient, or to help with entering and exiting the bed.

It is also known that patients egress from a side of the bed. Before the patient is able to egress, the foot siderail assembly is moved to the lowered position. The patient must then rotate the patient's body on the support surface to face toward the side, swing the patient's legs over the side of the bed, and remain sitting in an upright position without support from the support surface to the patient's back or support from the foot siderail assembly. Such coordinated movement to egress from the side of the bed may be difficult for some patients and some patients may require aid from a caregiver to egress from the side of the bed.

It is also known that patients egress from the chair the chair position of the bed. The chair position may be more suitable to some patients. With the bed in the chair position, the patient begins with the patient's feet resting on the floor, the patient sitting in the upright position, and the patient's back being supported by the support surface. To egress from the bed, the patient supports a portion of the patient's weight on the support surface on each side of the patient or on a caregiver standing next to the bed. The patient then leans forward and transfers the remaining weight to the patient's feet.

### SUMMARY

The present application discloses one or more of the features recited in the appended claims and/or the following features which, alone or in any combination, may comprise patentable subject matter.

According to one aspect of the present disclosure, a patient support apparatus includes a base, a frame, a deck, and an egress unit. The frame is coupled to the base and is movable relative to the base. The deck is supported by the frame and is movable relative to the frame between a horizontal position and an articulated position. The deck includes at least a head section, a foot section spaced-apart from the head section, and a seat section positioned between the head section and the foot section. The foot section is pivotable about a first lateral pivot axis relative to the frame. The egress unit is coupled to the foot section of the deck and is movable between a storage position and a use position. When the egress unit is in the storage position, the egress unit lies below a top surface of the foot section. When the egress unit is in the use position, the egress unit extends in an upward direction away from the top surface of the foot section to support a portion of a patient's weight so that a patient can egress from the patient support apparatus.

In some embodiments, the egress unit includes a handle couples to the foot section. The handle may move about a lateral pivot axis between a lowered position and a raised position. The handle, when in the lowered position, may lie below the top surface of the foot section. The handle, when in the raised position, may extend extend above the top surface of the foot section.

The foot section may include a head edge, a foot edge, and a first longitudinal edge. The foot edge may be spaced-apart from and generally parallel to the head edge. The first longitudinal side may extend between and may interconnect the head and foot edges of the foot section. The handle may be coupled to the first longitudinal side of the foot section and may extend away from the foot section in a lateral direction.

In some embodiments, the foot section includes a head edge, a foot edge, and a recess. The foot edge may be spaced-apart from and generally parallel to the head edge. The recess may be formed in the foot section and may receive the handle therein when the handle is in the lowered position to cause a maximum width of the foot section to be about equal to a first foot-section width defined by the foot edge.

In some embodiments, the foot section the top surface arranged to face in an upward direction when the patient support apparatus is in the horizontal position and an opposite bottom surface arranged to face in an opposite downward direction when the patient support apparatus is in the horizontal position. The handle may be coupled to the bottom surface of the foot section. The handle may be arranged to extend in the downward direction when the handle is in the lowered position.

The egress unit may include a handle and a slide assembly. The slide assembly may lie between and may interconnect the handle to the foot section of the deck. The slide assembly may be movable between a retracted position and an extended position. When the slide assembly is in the retracted position, the handle may be positioned to lie adjacent to the foot section. When the slide assembly is in the extended position, the handle may lie in spaced-apart relation to the foot section.

The slide assembly may translate back and forth about a lateral pivot axis. The handle may be movable relative to the slide assembly about the lateral pivot axis between a lowered position and a raised position. When the handle is in the lowered position, the handle may lie below the top surface of the foot section. When the handle is in the raised position, the handle may have rotated about the lateral pivot axis to extend away from the top surface of the foot section.

In some embodiments, the handle includes a grip and an arm. The grip may be adapted to be grasped by a patient during egress from the patient support apparatus. The arm may interconnect the grip to the slide assembly to cause the grip to rotate about lateral pivot axis away from the foot section toward the seat section to assume the raised position.

In some embodiments, the handle further includes a grip joint. The grip joint may be arranged to lie between and may interconnect the grip to the arm to cause the grip to pivot about an arm axis between a first position, a second position, and a third position. The grip, when in the first position, may extend away from the handle axis toward a foot end of the patient support apparatus. The grip, when in the second position, may extend away from handle axis toward an opposite head end of the patient support apparatus. The grip, when in the third position, may extend away from the handle axis toward a longitudinal axis of the patient support apparatus.

The slide assembly may include a slide tube and a slide-tube receiver. The slide-tube may be coupled to the arm to move therewith. The slide-tube receiver may be coupled to the foot section to move therewith. The slide-tube receiver may support the slide tube therein for back-and-forth movement along the lateral pivot axis between the extended and retracted positions.

The egress unit may further include a position controller that may include a grip lock, a handle lock, and a slide lock. The grip lock may selectively block movement of the grip about the handle axis relative to the arm. The handle lock may selectively block movement of the handle about the lateral pivot axis relative to the slide tube. The slide lock may selectively block movement of the slide assembly about the lateral pivot axis relative to the foot section.

In some embodiments, the egress unit includes a handle coupled to the foot section of the deck to move about a lateral pivot axis between a lowered position, a first raised position, and a second raised position. When the handle is in the lowered position, the handle may be positioned to lie below the top surface of the foot section. When the handle is in the first raised position, the handle may extend above the top surface of the foot section and may define a first angle between the handle and the top surface of the foot section of about 90 degrees. When the handle is in the second raised position, the handle may extend above the top surface of the foot section and may define a second angle between the handle the top surface of the foot section of greater than 90 degrees.

According to another aspect of the present disclosure, a patient support apparatus includes a base, a frame, a deck, and a handle. The frame is coupled to the base and is movable relative to the base. The deck is supported by the frame and movable relative to the frame between a horizontal position and an articulated position. The deck includes at least a head section, a foot section spaced-apart from the head section, and a seat section positioned between the head and foot sections. The seat section includes a foot edge, an oppositely spaced-apart head edge, a first longitudinal edge, and an opposite second longitudinal edge. The first longitudinal edge is arranged to extend between the foot and the head edges. The second longitudinal edge is arranged in spaced-apart generally parallel relation to the first longitudinal edge. The foot section is pivotable about a first lateral pivot axis relative to the frame. The handle is coupled to the foot section to move about a pivot axis in a first direction relative to the foot section from a lowered position to a raised position. The handle, when in the lowered position, is generally parallel with and adjacent to the first longitudinal side of the foot section. The handle, when in the raised position, extends in an upward direction away from the foot section.

In some embodiments, the patient support apparatus further includes a slide assembly that includes a slide-tube receiver and a slide tube. The slide-tube receiver may be coupled to the foot section in a fixed position. The slide tube may be coupled to the slide-tube receiver to translate back and forth along the pivot axis relative to the slide-tube receiver. The slide assembly may be in a retracted position when the slide tube lies between the first and second longitudinal sides of the foot section. The slide assembly may be in the extended position when the slide tube has translated along the pivot axis away from the first and second longitudinal edges of the foot section.

The patient support apparatus may further includes a slide lock. The slide lock may be coupled to the foot section and may be selectively movable from a locked position to a freed position. The slide lock may interconnect the slide tube to slide-tube receiver to block movement of the slide tube relative to the slide-tube receiver when the slide lock is in the locked position. The slide lock may allow movement of the slide tube relative to the slide-tube receiver when the slide lock is in the freed position.

In some embodiments, the patient support apparatus further includes a handle lock that is coupled to the foot section. The handle lock may be selectively movable from a locked position to a freed position. The handle lock, when in the locked position, may block movement of the handle about the pivot axis relative to the foot section. The handle, when in the freed position, may allow movement of the handle about the pivot axis relative to the foot section.

The handle may include a grip, a mount, and a handle joint. The grip may be adapted to be grasped by a patient during egress from the patient support apparatus. The mount may be coupled on a first end to the grip. The handle joint may interconnect an opposite second end of the mount to the foot section to cause the mount and the grip to rotate about the pivot axis in a first direction away from the foot section toward the seat section to assume the raised position. The handle may further include a grip mount. The grip mount may lie between and may interconnect the grip and the mount to cause the grip to rotate about a handle axis relative to the mount.

In some embodiments, the handle axis intersects the pivot axis about a right angle. The pivot axis may be spaced-apart from and may be generally parallel to the first lateral pivot axis.

According to another aspect of the present disclosure, a patient support apparatus comprises a base, a frame, a deck, and an egress unit. The frame is coupled to the base and is movable relative to the base. The deck is supported by the frame and is movable relative to the frame between a horizontal position and a chair-egress position. The deck includes a head section, a foot section spaced-apart from the head section, and a seat section positioned between the head and the foot sections. The seat section includes a foot edge, an opposite head edge, a first longitudinal edge extending between the head and the foot edges, and a second longitudinal edge spaced-apart from and generally parallel to the first longitudinal edge. The head section pivots upwardly about a first lateral pivot axis relative to the seat section and the foot section pivots downwardly about a second lateral pivot axis relative to seat section when the deck is in the chair-egress position. The egress unit includes a slide assembly and a handle. The slide assembly includes a slide-tube receiver and a slide tube. The slide-tube receiver is coupled to the foot section in a fixed position and is arranged to extend away from the foot section in a lateral direction. The slide tube is coupled to the slide-tube receiver to translate along a third lateral pivot axis relative to the slide-tube receiver. The slide assembly is in a retracted position when the slide tube lies between the first and second longitudinal sides of the foot section. The slide assembly is in an extended position when the slide tube has translated along the third lateral pivot axis away from the first and second longitudinal sides of the foot section. The handle is coupled to the slide tube to translate back and forth with the slide tube about the third lateral pivot axis. The handle is movable relative to the slide tube about the third lateral pivot axis when the slide assembly is in the extended position from a lowered position to a raised position. The handle is in the lowered position when the handle is generally aligned with the first longitudinal side of the foot section. The handle is in the low and a raised position in which the handle extends in an upward direction away from the slide tube, and wherein the third lateral pivot axis is generally parallel to the first and second lateral pivot axes.

According to another aspect of the present disclosure, a patient support apparatus includes a base, a frame, a deck, a siderail, a slide assembly, and a handle. The frame may be coupled to the base and may be movable relative to the base. The deck is supported by the frame and is movable relative to the frame between a horizontal position and an articulated position. The deck includes at least a head section, a foot section spaced-apart from the head section, and a seat section positioned between the head and foot sections. The seat section includes a foot edge, an oppositely spaced-apart head edge, a first longitudinal edge arranged to extend between the foot and the head edges, and an opposite second longitudinal edge arranged in spaced-apart generally parallel relation to the first longitudinal edge. The foot section is pivotable about a first lateral pivot axis relative to the frame. The siderail is coupled the frame between the head edge and the foot edge of the seat section and is arranged to extend along one of the first and second longitudinal edges of the seat section. The slide assembly includes a slide-tube receiver that is coupled to the seat section in a fixed position and a slide tube that is coupled to the slide-tube receiver to translate along an axis relative to the slide-tube receiver. The slide assembly is in a retracted position when the slide tube lies between the foot and the head ends of the seat section. The slide assembly is in an extended position when the slide tube has translated along the axis away from the foot and the head edges of the seat section toward a foot end of the patient support apparatus. The handle is coupled to the slide tube to move therewith about the axis. The handle is movable relative to the slide-slide tube receiver about a pivot axis when the slide-tube receiver is in the extended position. The handle moves from a first position to a second position. The handle, when in the first position, extends generally perpendicularly away from the axis to define an angle measured in a second direction between a horizontal plane that is generally coplanar with the axis and the handle. The angle is between about 0 degrees and about 180 degrees. The handle, when in the second position, extends in an upward direction away from the axis.

According to another aspect of the present disclosure, a patient support apparatus includes a base, a frame, a deck, a siderail assembly, a head panel, a foot panel, and a utility apparatus. The frame is coupled to the base and is movable relative to the base. The deck is supported by the frame and is movable relative to the frame between a horizontal position and an articulated position. The deck includes at least a head section, a foot section spaced-apart from the head section, and a seat section positioned between the head section and the foot section. The foot section is pivotable about a first lateral pivot axis relative to the frame and the foot section includes a top surface, an opposite bottom surface, a first longitudinal side, a second longitudinal side spaced-apart from the first longitudinal side, a head side extending between and interconnecting the longitudinal sides, and a foot side spaced-apart from and parallel to the head side. The siderail assembly includes a linkage and a barrier. The linkage is coupled to the frame below the seat section and between the head and the foot section. The barrier is coupled to the linkage to move relative to the deck between a raised position wherein the barrier is substantially above the seat section of the deck and a lowered position wherein the barrier is substantially below the seat section of the deck. The head panel is coupled to the frame at a head end of the frame to move therewith. The foot panel is selectively coupled to the foot section of the deck and is arranged to extend in an upward direction away from the foot section. The foot panel is arranged to extend along the foot side of the foot section between the first and second longitudinal sides. The utility apparatus is configurable to provide one of a storage mode and a use mode. When the utility apparatus is in the storage mode, the utility apparatus is positioned to lie out of a foot-section gap defined between the footboard and the siderail assembly. When the utility-apparatus is in the first-use mode, the utility apparatus is coupled to the foot section of the deck along the first longitudinal side of the foot section to extend in the upward direction into the siderail-section gap to support a portion of a patient's weight to allow a patient to egress from the patient support apparatus.

In some illustrative embodiments, the patient support apparatus further includes a second siderail assembly. The second siderail assembly may include a linkage and a barrier. The linkage may be coupled to the head section of the deck to move therewith. The barrier may be coupled to the linkage to move between a between a raised position wherein the barrier is substantially above the head section of the deck and a lowered position wherein the barrier is substantially below the head section of the deck.

The patient support apparatus may be in the horizontal position, the siderail assembly may be in the lowered position, and the utility apparatus may be configured to assume the first use mode to cause a seat-section gap to be formed between the utility apparatus and the second siderail assembly. The seat-section gap may be established to allow a patient to egress from the patient support apparatus while supporting a portion of the patient's weight on the utility apparatus.

In some embodiments, the utility apparatus includes a panel and a panel mount. The panel mount may be used to selectively couple the panel to the foot panel to establish the storage mode. The panel mount may also be used to selectively couple the panel to the foot section to establish the use mode.

The panel mount may include a panel lock and a panel pivot. The panel pivot may be used to interconnect the panel to the foot section to cause the panel to move between a lowered position and a raised position. The panel may extend in a downward direction away from the foot section toward the ground when the utility apparatus is in the lowered position. The panel may extend in an upward direction away from the foot section when the utility apparatus is in the raised position. The panel may rotate about a panel-pivot axis from the lowered position to the raised position by rotating abut 180 degrees.

According to another aspect of the present disclosure, a patient support apparatus includes a base, a frame, a deck, a siderail, a head panel, and a foot panel. The frame is coupled to the base to move relative to the base. The deck is supported by the frame to move relative to the frame between a bed position and a chair-egress position. The deck includes a head section, a foot section spaced-apart from the head section, and a seat section positioned between the head section and the foot section. The foot section is pivotable about a first lateral pivot axis relative to the frame. The foot section includes a top surface, an opposite bottom surface, a first longitudinal side, a second longitudinal side spaced-apart from the first longitudinal side, a head side extending between and interconnecting the longitudinal sides, and a foot side spaced-apart from and parallel to the head side. The siderail assembly includes a linkage and a barrier. The linkage is coupled to the frame below the seat section and between the head and the foot sections. The barrier is coupled to the linkage to move relative to the deck between a raised position and a lowered position. The barrier is in the raised position when the barrier is substantially above the seat section of the deck. The barrier is in the lowered position wherein the barrier is substantially below the seat section of the deck. The barrier remains in a general vertical orientation while moving between the raised and the lowered positions. The head panel is coupled to the frame at a head end of the frame to move therewith. The foot panel is selectively coupled to the foot section of the deck to extend in an upward direction away from the foot section. The foot panel includes a first side arranged to faced toward the head panel and a second side spaced-apart from and arranged to face opposite the first side.

In some embodiments, the patient support apparatus includes a first utility apparatus that is configurable to provide one of several modes of use. The first utility apparatus may be in a storage mode when the utility apparatus is coupled to the foot panel to lie outside a perimeter of the foot section and when the patient support apparatus is not in the chair-egress position. The first utility apparatus may be in a gap-filling mode when the utility apparatus is coupled to the foot section of the deck along the first longitudinal side to extend into a foot-section gap that is defined between the foot panel and the siderail assembly and when the deck is in the bed position and when the siderail assembly is in the raised position. The patient support apparatus may have a first length when the utility apparatus is in a gap-filling mode.

The utility apparatus may be further configured to assume a side-egress mode when the deck is in the bed position and the siderail assembly is in the lowered position. The utility apparatus may be coupled to the foot section of the deck along the first longitudinal side to extend away from the top surface of the foot section when arranged in the side-egress mode.

In some embodiments, the utility apparatus may be further configured to assume a chair-egress mode when the deck is in the chair-egress position. The utility apparatus may be coupled to the foot section of the deck along the first longitudinal side of the foot section to extend away from the top surface of the foot section when arranged in the chair-egress position. The patient support apparatus may have a second length when the utility apparatus is in the chair-egress position. The second length may be less than a first length of the patient support apparatus.

The utility apparatus may be further configured to assume a first-shelf mode when the deck is not in the chair-egress position. The utility apparatus may be coupled to the second side of the foot panel to extend away from the second side of the foot board when the utility apparatus is in a first-shelf mode. The patient support apparatus may have a third length when the utility apparatus is in the first-shelf mode. The third length may be greater than the first length.

The utility apparatus may also be configured to assume a second-shelf mode when the deck is not in the chair-egress position. The utility apparatus may coupled to the first side of the foot panel to lie spaced-apart above the seat section. The utility apparatus may be arranged to extend toward the head panel. The patient support apparatus may have the first length when the utility apparatus is in the second-shelf mode.

In some embodiments, the utility apparatus includes a panel and a panel mount. The panel may include a first side, a second side, a third side, and a fourth side. The second side may be spaced-apart from and generally parallel to the second side. The third side may extend between and interconnect the first and second sides. The fourth side may be spaced-apart from and generally parallel to the third side. The first, second, third, and fourth sides may cooperate to establish a perimeter of the panel.

The panel mount may include a first pin, a second pin, and a third pin. The pins may be movable between a retracted position and an extended position. The pins may lie in associated spaces formed in the panel when in the retracted position. The pins may extend away from the second side when in the extended position.

The top surface of the foot section of the deck may be formed to include a panel-mount receiver. The panel-mount receiver may include a first pin and a second pin aperture. The first pin aperture may be aligned with and configured to receive the third pin therein. The second pin aperture may be aligned with and configured to receive the second pin therein. The second and third pins may mate with the first and second apertures when the utility apparatus is in one of the gap-filling mode, the side-egress mode, and the chair-egress mode.

In some embodiments, the panel mount includes a panel pivot that is arranged to interconnect the panel to the foot section of the deck. The panel mount may cause the panel to pivot about a panel rotation axis between the storage position and the first-use position. The panel mount may also include a panel lock that may be arranged to selectively block movement of the panel about the panel rotation axis. The panel rotation axis may be generally spaced-apart from and parallel to the first longitudinal side of the seat section.

Additional features, which alone or in combination with any other feature(s), including those listed above, those listed in the claims, and those described in detail below, may comprise patentable subject matter. Other features will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description particularly refers to the accompanying figures in which:

FIG. 1 is a perspective view of a patient support apparatus in a generally flat horizontal configuration with a pair of egress units in a storage position;

FIG. 2 is a view similar to FIG. 1 with a patient-right egress unit in a bed first-use position and a patient-left egress unit in a bed second-use position;

FIG. 3 is a perspective view of the patient support apparatus of FIGS. 1 and 2 moved to a chair-egress position with the pair of egress units in the storage position;

FIG. 4 is a view similar to FIG. 3 with the patient-right egress unit in the chair-egress first-use position and the patient-left egress unit in a chair-egress third-use position;

FIGS. 5-7 are a series of views of another embodiment of a patient-left egress unit moving from a storage position to a bed first-use position and finally to a bed second-use position;

FIG. 5 is an enlarged partial perspective view an egress unit in the storage position;

FIG. 6 is a view similar to FIG. 5 with the egress unit in the bed first-use position;

FIG. 7 is a view similar to FIG. 6 with the egress unit in the bed second-use position;

FIGS. 8-11 are a series of views of another embodiment of a patient-left egress unit moving from a storage position, to an intermediate position, to a chair-egress first-use position, and finally to a chair-egress third-use position;

FIG. 8 is an enlarged partial perspective view of an egress unit in the storage position;

FIG. 9 is a view similar to FIG. 8 with the egress unit in the intermediate position;

FIG. 10 is a view similar to FIG. 9 with the egress unit in the chair-egress first-use position and a diagrammatic view of a position controller;

FIG. 11 is a view similar to FIG. 10 with the egress unit in the chair-egress third-use position;

FIG. 12 is a sectional taken view taken along a section line of FIG. 8 showing a slide lock in a locked position;

FIG. 13 is a view similar to FIG. 12 with the slide lock in the freed position;

FIG. 14 is an enlarged exploded partial perspective view of a handle lock in a locked position;

FIG. 15 is an enlarged exploded partial perspective view of a grip lock in a locked position;

FIG. 16 is an enlarged perspective view of a utility apparatus that may be coupled to a patient support apparatus and configured for various modes of use as shown in FIGS. 17-22;

FIG. 17 is a perspective view of another patient support apparatus in a bed position with a pair of utility apparatuses in a storage mode;

FIG. 18 is a view similar to FIG. 17 with the pair of utility apparatus transitioning from the storage mode of FIG. 17 to a gap-filling mode as shown in FIG. 19;

FIG. 19 is a view similar to FIG. 18 with the pair of utility apparatuses arranged in a gap-filling mode that fills a gap formed between a foot siderail assembly and a foot panel;

FIG. 20 is a view similar to FIG. 19 with the utility apparatus arranged in a side-egress mode;

FIG. 21 is a perspective view of the patient support apparatus of FIG. 17 with the patient support apparatus in a chair-egress position and the utility apparatuses arranged in the chair-egress mode;

FIG. 22 is a view similar to FIG. 20 with the utility apparatus arranged in a first-shelf mode;

FIG. 23 is a partial perspective view of the patient support apparatus of FIG. 22 with the utility apparatus arranged in a second-shelf mode;

FIG. 24 is a perspective view of another utility apparatus in a raised position that may be coupled to a foot section of a patient support apparatus having a utility apparatus in a raised position; and

FIG. 25 is a view similar to FIG. 24 of the utility apparatus moved to a lowered position.

### DETAILED DESCRIPTION OF THE DRAWINGS

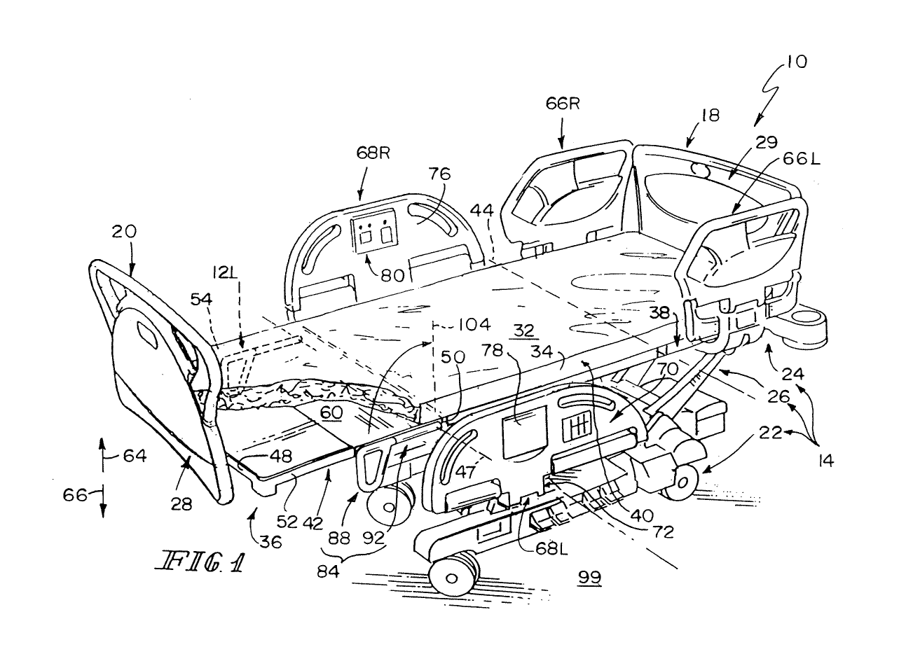

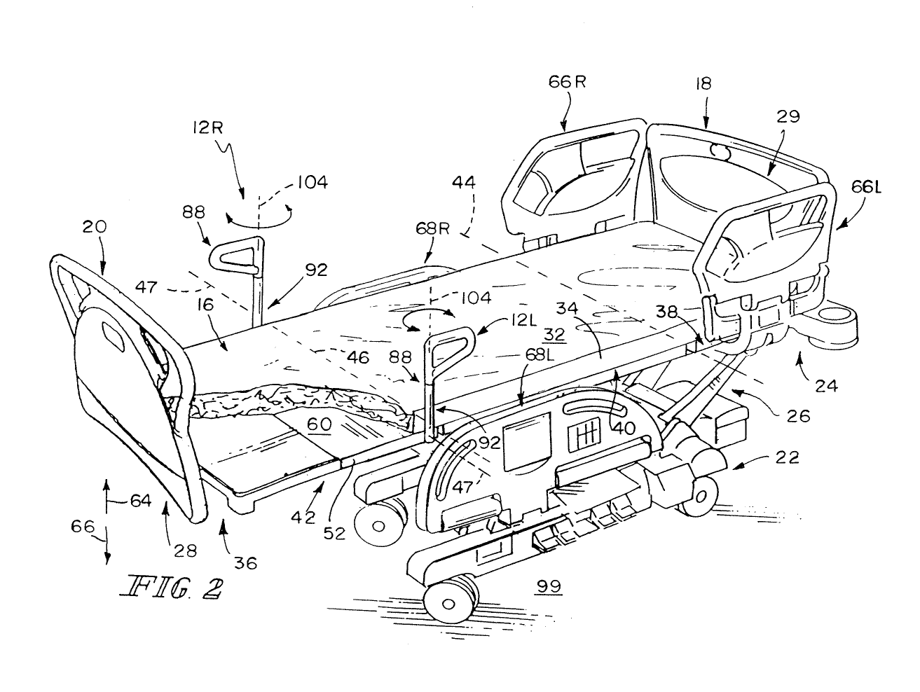

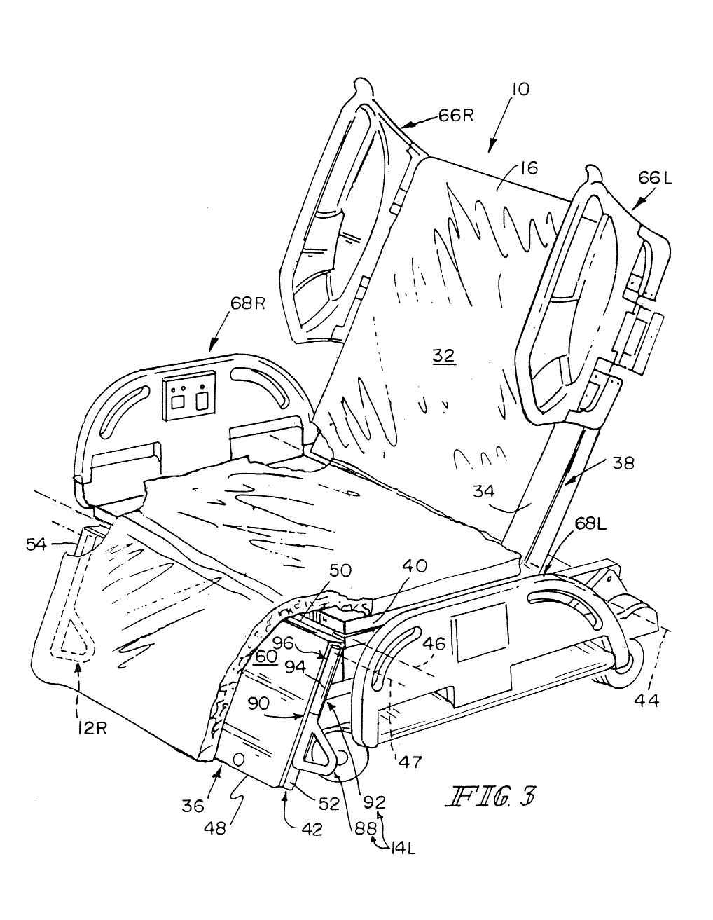

A patient support apparatus, such as a hospital bed 10 is shown, for example, in FIGS. 1-4. The hospital bed 10 is movable between a bed position, as shown in FIGS. 1 and 2, and a chair-egress position as shown in FIGS. 3 and 4. The hospital bed 10, when in the bed position, provides support to a patient (not shown) such that the patient's feet are supported spaced-apart from the ground 99. The hospital bed 10, when in the chair-egress position, provides support to a patient such that the patient sits upright and the patient's feet are positioned on the ground 99. The bed position and the chair-egress position may be used by patients and by caregivers to help patients egress or exit the hospital bed 10. As shown in FIGS. 1-4, a pair of egress units 12R, 12L are included in the hospital bed 10. The egress units 12R, 12L are movable between a storage position shown in FIGS. 1 and 3 and one of several use positions shown in FIGS. 2, 4, 6, 7, 10, and 11. When the egress units 12R, 12L are in one of the use positions, a patient may support a portion of his or her weight on the egress units 12R, 12L during egress from the hospital bed 10.

The hospital bed 10 further includes a frame 14 and a mattress 16 that is supported by the frame 14 as shown in FIGS. 1-4. The hospital bed 10 has a head end 18 and a foot end 20. The frame 14 includes a base 22 and an upper frame 24 coupled to the base 22 by an elevation system 26. The elevation system 26 is operable to raise, lower, and tilt the upper frame 24 relative to the base 22. The hospital bed 10 further includes a foot panel 28 positioned adjacent the foot end 20 and a head panel 29 positioned adjacent the head end 18. The foot panel 28 is removable and is removed prior to moving the hospital bed 10 into the chair-egress position shown in FIGS. 3 and 4.

The mattress 16 of the hospital bed 10 includes a top surface 32, a bottom surface (not shown), and a perimeter surface 34 as shown in FIGS. 1-4. The upper frame 24 of the frame 14 supports a deck 36 with the mattress 16 supported on the deck 36. The deck 36, as shown in FIGS. 1-4, includes a head section 38, a seat section 40, and a foot section 42. The head section 38 pivotably raises and lowers about a first lateral pivot axis 44 relative to the seat section 40 and the seat section 40 pivotably raise and lowers about a second lateral pivot axis 46. Additionally, the seat section 40 pivotably raises and lowers relative to the upper frame 24. Also, the foot section 42 is extendable and retractable to change an overall length of the foot section 42, and therefore, to change an overall length of the deck 36.

In some embodiments, the seat section 40 also moves, such as by translating on the upper frame 24, as the hospital bed 10 moves between the bed position, also called the horizontal position, and the chair-egress position, also called the articulated position. In those embodiments where the seat section 40 translates along the upper frame 24, the foot section 42 also translates along with the seat section 40. As the hospital bed 10 moves from the bed position to the chair-egress position, the foot section 42 lowers about the second lateral pivot axis 46 relative to the seat section 40 and shortens in length. As the hospital bed 10 moves from the chair-egress position to the bed position, the foot section 42 raises relative to the seat section 40 and increases in length. Thus, in the chair-egress position, the head section 38 extends generally vertically upwardly from the upper frame 30 and the foot section 42 extends generally downwardly from the upper frame 30 as shown in FIGS. 3 and 4.

The foot section 42 includes a foot edge 48, an opposite head edge 50, a first longitudinal edge 52, a second longitudinal edge 54, a top surface 60, and an opposite bottom surface. The foot edge 48 is spaced-apart from and generally parallel to the opposite head edge 50. The first longitudinal edge 52 is spaced-apart from and generally parallel to the opposite second longitudinal edge 54. The first and second longitudinal edges 52, 54 extend between the head and the foot edges 48, 50. Together, all the edges 48, 50, 52, 54 cooperate together to define a perimeter of the foot section 42. The top surface 60 is arranged to face in an upward direction 64 and extend between the four edges 48, 50, 52, 54 of the foot section 42. The bottom surface is spaced-apart below the top surface 60, faces in an opposite downward direction 66, and extends between the four edges 48, 50, 52, and 54 as shown in FIGS. 3 and 4. The second lateral pivot axis 46 is parallel to and between the head edge 50 and the seat section 40. A second lateral pivot axis 46 is generally parallel to the second lateral pivot axis 46 and the first lateral pivot axis 44. The third lateral pivot axis 47 is between the head edge 50 of the foot section 42 and the foot panel 28 as shown in FIG. 1.

The hospital bed 10 also includes four siderail assemblies coupled to the upper frame 24: a patient-right head siderail assembly 66R, the patient-right foot siderail assembly 68R, a patient-left head siderail assembly 66L, and a patient-left foot siderail assembly 68L. Each of the siderail assemblies 66R, 66L, 68R, 68L is movable between a raised position, as shown in FIGS. 1 and 2, and a lowered position. Siderail assemblies 66R, 66L, 68R, 68L are sometimes referred to as siderails 66R, 66L, 68R, 68L herein.

The left foot siderail 68L is similar to the other siderails 66R, 66L, and 68R, and thus, the following discussion of the left foot siderail 68L is equally applicable to other siderails 66R, 66L, and 68R. The siderail 68L includes a barrier panel 70 and a linkage 72. The linkage 72 interconnects the barrier panel 70 to the upper frame 24 and guides the barrier panel 70 during movement of the siderail 68L between the raised and the lowered positions while maintaining the barrier panel 70 in a substantially vertical orientation throughout.

The barrier panel 70 includes an outward side 74 and an oppositely facing inward side 76. As shown in FIGS. 1-4, the inward side 76 faces toward the mattress 16 and the outward side 74 faces away from the mattress 16. A first user interface 78 is coupled to the outward side 74 of the barrier panel 70 for use by a caregiver (not shown). As shown in FIGS. 1-4, a second user interface 80 is coupled to the inward side 76 for use by a patient (not shown). Both the first and second user interfaces 78, 80 are coupled electrically to a bed controller 82 included in the hospital bed 10. The user interfaces 78, 80 allow caregivers and patients to control movement of the elevation system 26 as well as other features of the hospital bed 10.

As discussed previously, the hospital bed 10 also includes the patient-right egress unit 12R and the patient-left egress unit 12L. The patient-left egress unit 12L is similar to the patient-right egress unit 12R, and thus, the following discussion of the patient-left egress unit 12L is equally applicable to the patient-right egress unit 12R. The egress units 12L, 12R may also be called utility apparatuses 12L, 12R. Also, the patient-left egress unit 12L may also be called the egress unit 12 herein. As shown in FIGS. 1-4, the egress unit 12 includes an egress handle 84 and a position controller 86. The egress handle 84 is coupled to the foot section 42 to move relative to the foot section 42 between a lowered position shown in FIGS. 1 and 3, a first raised position shown in FIG. 2, and a second raised position shown in FIG. 4. The position controller 86 selectively blocks movement of the handle 84 relative to the foot section 42.

The egress handle 84, as shown in FIGS. 1-11, includes a grip 88, a grip joint 90, and an arm 92. The grip joint 90 lies between and interconnects the grip 88 to the arm 92 so that the grip 88 is able to move relative to the arm 92. The arm 92 is coupled to the foot section 42 to cause the grip 88 and the grip joint 90 to move together about the third lateral pivot axis 47. When the handle 84 is in the lowered position shown in FIGS. 1 and 3, the grip 88, the grip joint 90, and the arm 92 lie below the top surface 60 of the foot section 42. When the handle 84 is in the first raised position of FIG. 2, the arm 92 extends from below the top surface 60 in the upward direction 64 at about 90 degrees relative to the top surface 60 to cause the grip joint 90 and the grip 88 to lie above the top surface 60 of the foot section. When the handle 84 is in the second raised position of FIG. 4, the arm 92 extends from below the top surface 60 in the upward direction 64 at about 150 degrees relative to the top surface 60 to cause the grip joint 90 and the grip 88 to lie above the top surface 60 of the foot section 42. The angle between the handle 84 and the top surface 60 of the seat section 60 is greater when the handle 84 is in the second raised position that when the handle 84 is in the first raised position because the foot section 42 has rotated downwardly relative to the seat section 40 as shown in FIG. 4.

Arm 92 includes a handle mount 94 and a handle joint 96 as shown in FIGS. 3-4. Handle mount 94 is coupled to grip joint 90 on a first end and is coupled to handle joint 96 on an opposite second end. Handle joint 96 lies between and interconnects the handle mount 94 and the foot section 42 to cause the grip 88, the grip joint 90, and the handle mount 94 to pivot about the third lateral pivot axis 47 between the lowered position and the raised position as shown in FIGS. 3 and 4.

As shown in FIG. 14, the grip 88 includes a first grip bar 98, a second grip bar 100, and a third grip bar 102. The first grip bar 98 is coupled on a first end to the grip joint 90 to pivot about a handle axis 104 relative to the handle mount 94. The handle axis 104 is arranged to intersect the third lateral pivot axis 47 at about a right angle. As illustrated in FIG. 14, the first grip bar 98 is generally collinear with the handle mount 94. The second grip bar 100 is coupled to a second opposite end of the first grip bar 98 to extend away from the first grip bar 98 at about a right angle. The third grip bar 102 interconnects the first and the second grip bars 98, 100. Together the first, the second, and the third grip bars 98, 100, 102 cooperate to establish a generally triangular shape of the grip 88 and to define an aperture 106 that is adapted to receive a patient's hand therein.

The grip 88 is able to pivot about the handle axis 104 between a first grip position shown in FIGS. 1 and 3, a second grip position shown in FIG. 2, and a third grip position shown in FIG. 4. The grip 88 may be in the first grip position when the handle 84 is in either the raised or the lowered positions as shown in FIGS. 1-4. Generally, the grip 88 is in the second and the third grip positions when the handle 84 is in one of the first and second raised positions. The grip 88 is in the first grip position and the handle 84 is in the lowered position when the grip 88 extends away from the bottom surface of the foot section 42 toward ground 99 and may be thought of as being at six o'clock. When the handle 84 is in the lowered position and the grip 88 is in the first grip position, the egress unit 12 is in the storage position.

As shown in FIG. 2, the handle 84 of the patient-right egress unit 12R is in the first raised position. The grip 88 of the handle 84 is in the first grip position which causes the grip 88 to extend away from the handle axis 104 toward the foot end 20. When the hospital bed 10 is in the bed position, the handle 84 is in the first raised position, and the grip is in the first grip position, the egress unit 12R is in a bed first-use position as shown in FIG. 2. When the hospital bed 10 is in the chair-egress position, the handle 84 is in the second raised position, and the grip is in the first grip position, the egress unit 12R remains in a chair-egress first-use position as shown in FIG. 4. The chair egress first-use position of the egress unit 12R may be used by some patients that desire a larger distance 108 between the egress units 12R and 12L as shown in FIG. 4.

The handle 84 of the patient-left egress unit 12L is in the first raised position and the hospital bed 10 is in the bed position. The grip 88 of handle 84 is in the second grip position when the grip 88 extends away from the handle axis 104 toward the head end 18 and may be thought of as being at twelve o'clock as shown in FIG. 2. When the handle 84 is in the first raised position and the grip 88 is in the second grip position, the egress unit 12L is in a bed second-use position. As shown in FIG. 2, the egress unit 12L is in the bed second-use position and the hospital bed 10 is in the bed position. The bed second-use position of the egress unit 12L may be used by a patient during egress from a side of the hospital bed 10. As an example, the patient may support a portion of his or her weight on the patient-left head siderail 66L and the egress unit 12L during egress from the side of the hospital bed 10.

While the handle 84 of the patient-left egress unit 12L is in the second raised position, the grip 88 may also be in the third grip position as shown in FIG. 4. The grip 88, when in the third position, extends away from the handle axis 104 toward the patient-right egress unit 12R and may be thought of as in the nine o'clock position. When the handle 84 is in the second raised position and the grip 88 is in the third grip position, the egress unit 12L is in a chair-egress third-use position. As shown in FIG. 4, the egress unit 12L is in the chair-egress third-use position and the hospital bed 10 is in the chair-egress position. The chair-egress third-use position of the egress unit 12L may be used by a patient during egress from the hospital bed 10. As an example, the patient may support a portion of his or her weight on the patient-right egress unit 12R and on the patient-left egress unit 12L. Both the egress units 12R, 12L may be moved to the chair-egress third-use position as a result of some patients desiring a smaller distance 110 between the egress units 12R and 12L as shown in FIG. 4.

As discussed previously, the egress unit 12 also includes the position controller 86. The position controller 86 includes a grip lock 130 and a handle lock 132 as shown diagrammatically in FIG. 4. The handle lock 132 is used to selectively block movement of the handle 84 about the third lateral pivot axis 47. The grip lock 130 is used to selectively block movement of the grip 88 about the handle axis 104. The grip lock 130 and the handle lock 132 may be coupled electronically to the bed controller 82 and may be moved separately or together from an unlocked position to a locked position by the bed controller 82 as illustrated in FIGS. 12, 13, and 14.

In use, the caregiver re-arranges the egress unit 12 by first moving the handle lock 132 from a locked position in which movement of the handle 84 is blocked to the freed position in which the handle 84 is permitted to move about the third lateral pivot axis 47 from the lowered position to one of the first and second raised positions. After the handle 84 is in one of the first and second raised positions, the caregiver re-engages the handle lock 132. Next, the caregiver moves the grip lock 130 from a locked position in which rotation of the grip 88 is blocked to the freed position in which the grip 88 is permitted to rotate about the handle axis 104 relative to the handle mount 94 from the first grip position to one of the second or third grip positions. Finally, the caregiver re-engages the grip lock 130 so that unintended movement of the grip 88 is blocked.

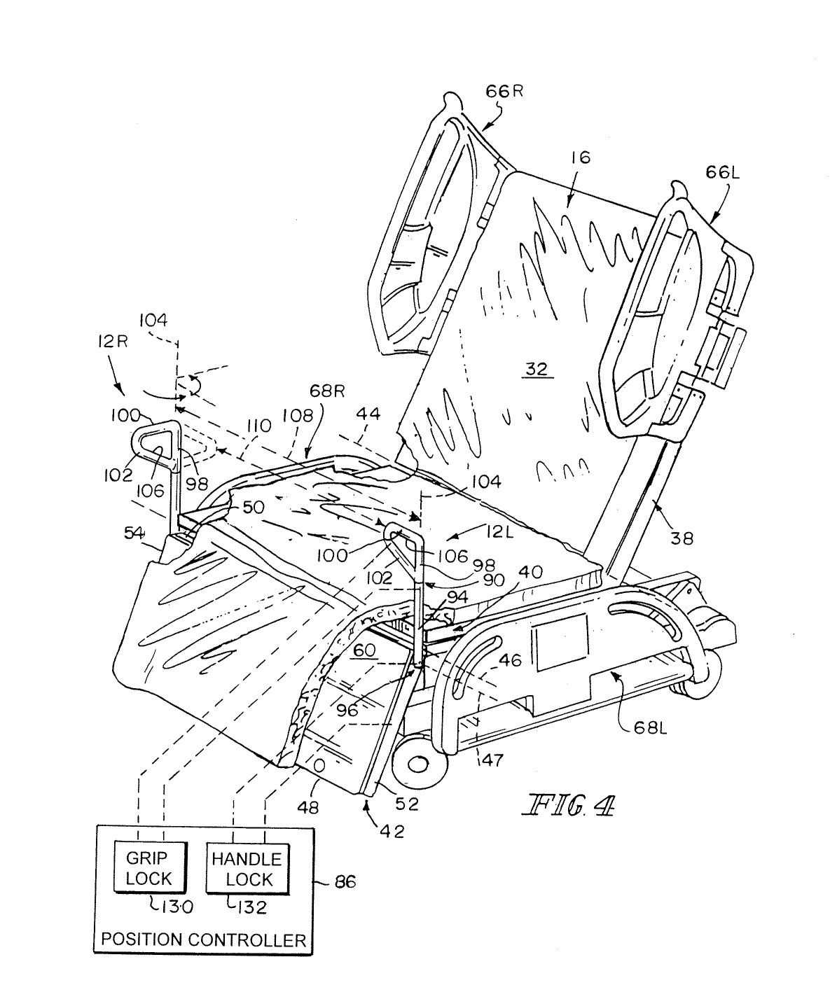

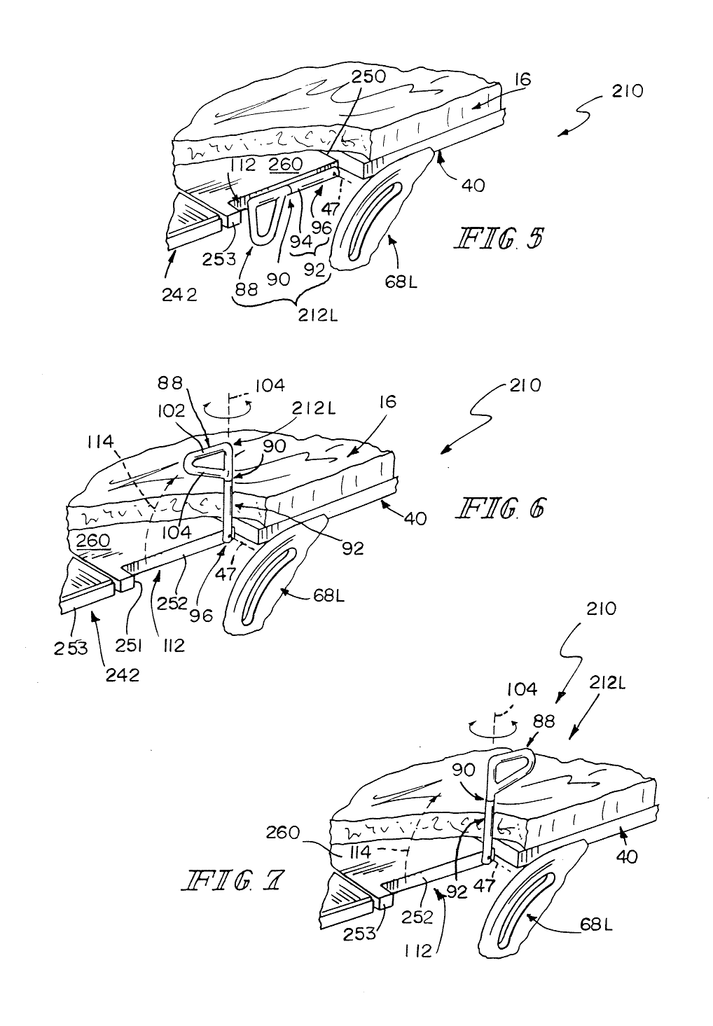

Another embodiment of an egress unit 212 is shown in FIGS. 5-7. The egress unit 12 is omitted from the hospital bed 210 and is replaced with the egress unit 212. The egress unit 212 includes handle 84. The handle 84 functions as previously described. One difference between egress unit 212 and egress unit 12 is the lowered position of the handle 84 and how the handle 84 couples to a foot section 242. The egress unit 212 is movable between a storage position shown in FIG. 5, a bed first-use position shown in FIG. 6, a bed second-use position shown in FIG. 7, and a bed third-use position (not shown), but similar to the third-use position shown in FIG. 4. The egress unit 212 is also movable between the storage position of FIG. 5, a chair-egress first-use position (similar to the chair-egress first-use position of egress unit 12R in FIG. 4), a chair-egress second-use position (similar to the chair-egress first-use position of egress unit 12L in FIG. 4), and a chair-egress third-use position (not shown).

The foot section 242 is similar to the previously described foot section 42, but foot section 242 is formed to include a patient-right recess and a patient-left recess 112 as shown in FIGS. 5-7. The foot section 242 includes a foot edge 48, a first head edge, a second head edge 250, a third head edge 251, a first longitudinal edge 252, a second longitudinal edge, a third longitudinal edge 253, and a fourth longitudinal edge. In series, the foot edge 48, the third longitudinal edge 253, the third head edge 251, the first longitudinal edge 252, the second head edge 250, the second longitudinal edge, the first head edge, and the fourth longitudinal edge cooperate to define a perimeter of the foot section 242. The second head edge 250 is generally parallel to and spaced-apart from the foot edge 48 by a first distance. The first and third head edges 251 are generally collinearly aligned with one another, generally parallel to and spaced-apart from the foot edge 48 by a second distance smaller than the first distance. The third longitudinal edge 253 extends between and interconnects the foot edge 48 and the third head edge 251. The third head edge 251 extends between and interconnects the third longitudinal edge 253 and the first longitudinal edge 252. The first longitudinal edge 252 extends between and interconnects the second head edge 250 and the third head edge 251 as shown in FIGS. 6 and 7.

The foot section 242 also includes a top surface 260 and an opposite bottom surface that is spaced-apart below and generally parallel to the top surface 260. The top surface 260 and the bottom surface are bounded by the perimeter.

The patient-left recess 112 is defined by the foot edge 48, the third longitudinal edge 253, the third head edge 251, the first longitudinal edge 252, and the second head edge 250 as shown in FIGS. 6 and 7. The handle 84 is coupled to the first longitudinal edge 252 adjacent to the intersection of the second head edge 250 and the first longitudinal edge 252. The handle 84 lies in the recess 112 below the top surface 260 when the handle is in the lowered position. When the handle 84 is in the first raised position, the handle 84 extends out of the recess 112 above the top surface 260 and establishes an angle of about 90 degrees with the top surface 260 as shown in FIGS. 6 and 7. When the handle 84 is in the second raised position, the handle 84 extends out of the recess 112 above the top surface 260 and establishes an angle of about 150 degrees with the top surface. As a result of the handle 84 being in the recess 112 when in the lowered position, a maximum width of the foot section is about equal to a width defined foot edge 48.

As illustrated in FIGS. 5 and 6, the handle 84 moves about the third lateral pivot axis 47 in a clockwise direction 114 represented by a phantom arrow 114 in FIG. 6 from the lowered position of FIG. 5 to the first raised position of FIG. 6. The grip 88 begins in the first grip position in FIG. 5 and remains in the first grip position as shown in FIG. 6. The egress unit 212L is in the bed first-use position when the grip 88 is in the first grip position and the handle 84 is in the first raised position. The grip 88 then rotates about the handle axis 104 as suggested in FIG. 6 and shown in FIG. 7 to either the second grip position shown in FIG. 7 or a third grip position similar to the third grip position shown in FIG. 4.

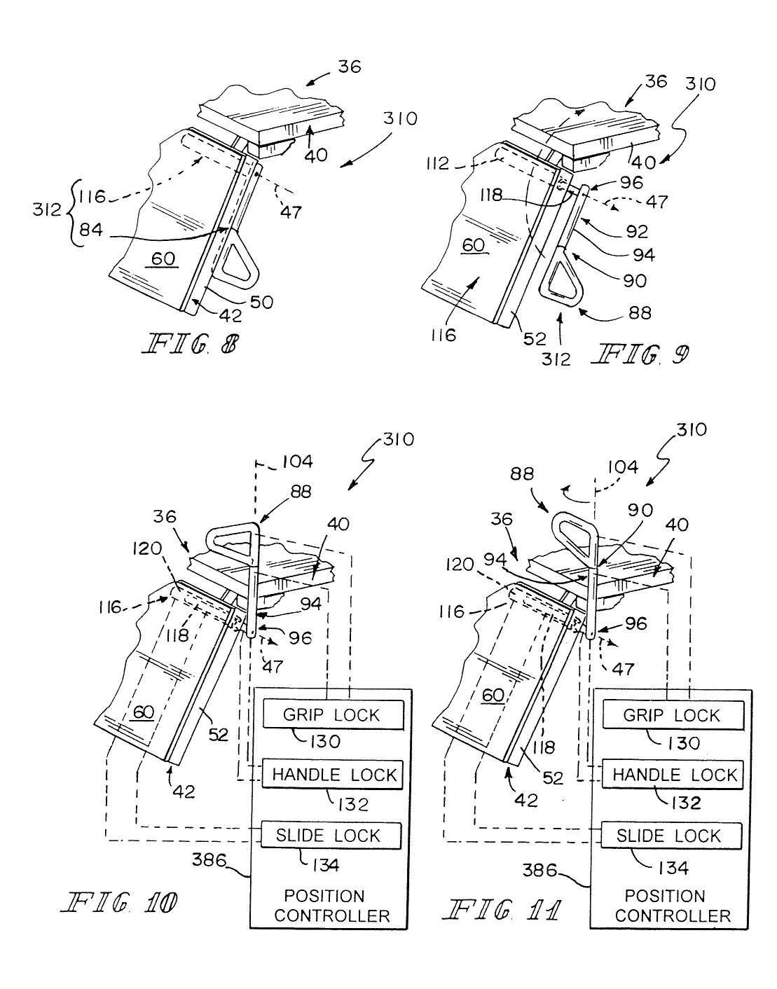

Another embodiment of an egress unit 312 is shown in FIGS. 8-11. The egress units 12 and 212 are omitted from the hospital bed 310 and are replaced with the egress unit 312. The egress unit 312 includes a handle 84 and a slide assembly 116 as shown in FIGS. 8 and 9. The slide assembly 116 is movable between a retracted position illustrated in FIG. 8 and an extended position shown in FIGS. 9-11. The handle 84 is coupled to the slide assembly 116 to move back and forth relative to foot section 42. As discussed previously, the handle 84 is able to move between the raised and the lowered positions when the slide assembly 116 is in the extended position.

The slide assembly 116 includes a slide tube 118 and a slide-tube receiver 120 as shown in FIGS. 8-11. The slide-tube receiver 120 is coupled to the bottom surface of the foot section 42 to move therewith. The slide tube 118 interconnects the egress handle 84 and the slide assembly 116 to cause the slide tube 118 and the egress handle 84 to move back and forth relative to the slide-tube receiver 120 to establish either the extended position or the retracted position of the slide assembly 116.

The slide assembly 116 is in the retracted position when the slide tube 118 lies in the perimeter of the foot section 42 and the egress handle 84 is in confronting relation with the bottom surface of the foot section 42 as shown in FIG. 8. The slide assembly 116 moves from the retracted position and assumes the extended position as a result of the slide tube 118 moving along the third lateral pivot axis 47 away from the slide-tube receiver 120 as shown in FIG. 9. The third lateral pivot axis 47 is defined by slide tube 118.

As shown in FIG. 9, the handle joint 96 of the egress handle 84 is coupled to the slide tube 118 to move therewith back and forth along the third lateral pivot axis 47 relative to the slide-tube receiver 120. The grip 88, the grip joint 90, and the handle mount 94 are coupled to the handle joint 96 to move therewith. The handle 84 is movable between the lowered position shown in FIGS. 8 and 9 and a second raised position shown in FIGS. 10 and 11. The handle 84 is also movable to a first raised position, but is not shown. When the handle 84 is in the lowered position, the handle mount 94 of the handle 84 extends away from the slide tube 118 at about a right angle to the third lateral pivot axis 47 along the first longitudinal edge 52 of the foot section 42. As shown in FIG. 8, the handle 84 extends along the bottom surface of the foot section 42. The handle 84 moves from the lowered position to the second raised position by rotating in a clockwise direction 114 indicated by arrow 114 about the third lateral pivot axis 47 about 150 degrees until the handle mount 94 extends away from the slide tube 118 and the top surface 60 of the foot section 42 in the upward direction 64.

A caregiver may use the egress unit 312 when a patient egresses from the hospital bed 310 by way of the chair-egress position or the bed position. As an example of use, the egress unit 212 begins in the storage position as shown in FIG. 8. Next, the caregiver slides the slide assembly 116 from the retracted position to the extended position as shown in FIG. 9. The caregiver is then able to rotate the handle 84 from the lowered position of FIG. 9 to the second raised position of FIG. 10. Finally, the caregiver moves the grip 88 about the handle axis 104 from the first grip position of FIG. 10 to the third grip position of FIG. 11 so that a distance between the egress units 312 is minimized.

As illustrated in FIGS. 10 and 11, egress unit 312 also includes a position controller 386. The position controller 386, like the position controller 86, includes the grip lock 130 and the handle lock 132. Unlike the position controller 86, the position controller 386 also includes a slide lock 134 as shown in FIGS. 10 and 11. The slide lock 134 retains the slide assembly 116 in either the retraced position of FIG. 8 or the extended position of FIGS. 9-11. To re-arrange the egress unit 312, a caregiver first moves the slide lock 134 from a locked position in which movement of the slide assembly 116 is blocked to the freed position in which the slide assembly 116 is permitted to move from the retracted position to the extended position. After the slide assembly 116 is in the extended position, the caregiver re-engages the slide lock 134. After the slide assembly 116 is in the extended position, the egress handle 84, the handle lock 132, and the grip lock 130 operate as previously described.

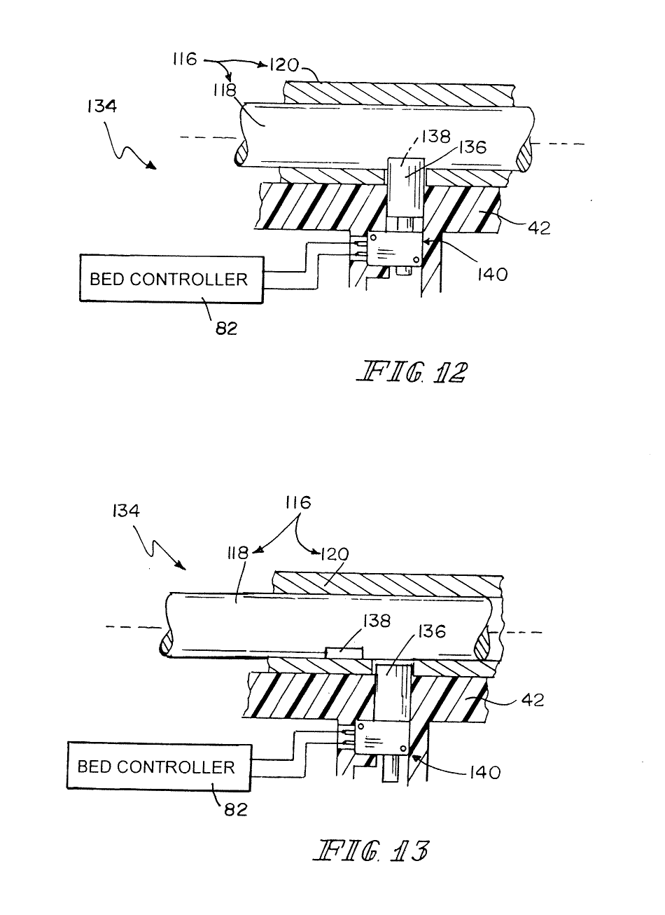

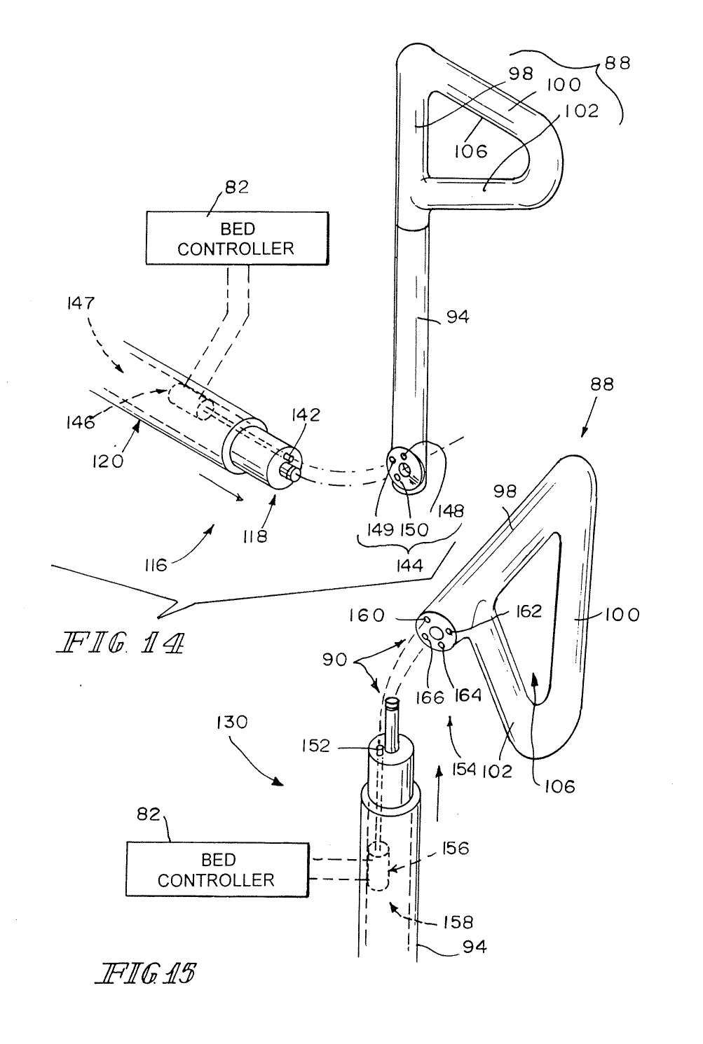

The slide lock 134 is movable between the locked position shown in FIG. 12 in which the slide tube 118 is blocked from moving relative to the slide-tube receiver 120 and the freed position shown in FIG. 13 in which the slide tube 118 is permitted to slide relative to the slide-tube receiver 120. The slide lock 134 includes a piston 136, a notch 138, and a slide-lock actuator 140. The notch 138 is formed in the slide tube 118 and is configured to mate selectively with the piston 136 therein. The slide-lock actuator 140 is coupled to the piston 136 and is configured to move the piston 136 back and forth relative to the notch 138 as shown in FIGS. 12 and 13. The slide-lock actuator 140 is a solenoid and is coupled electrically to the bed controller 82. The caregiver or the patient uses one of the user interfaces 78, 80 to command the bed controller 82 to cause the solenoid to move the piston 136 to the user desired position. While the slide-lock actuator 140 is shown as a solenoid, a mechanical actuator that uses an actuation force provided by a user may be used.

As shown in FIG. 12, the slide lock 134 is in the locked position when the piston 136 is in mating contact with the notch 138. The caregiver uses one of the user interfaces 78, 80 to command the bed controller 82 to cause the slide-lock actuator 140 to move the piston 136 away from notch 138 so that the slide lock 134 assumes the freed position. The caregiver is now able to slide the egress handle 84 away from the slide-tube receiver 120 from the retracted position to the extended position. The caregiver next commands the slide-lock actuator 140 to move toward another notch formed in the slide tube 118 so that the slide lock 134 assumes the locked position and blocks sliding movement of the slide tube 118 and the egress handle 84 relative to the slide-tube receiver 120.

The handle lock 132 is next moved from the locked position to the freed position. As shown in FIG. 14, the handle lock 132 includes a plunger 142, a receiver 144, and a handle-lock actuator 146 as shown in FIG. 14. The plunger 142 lies in a space 147 formed in the slide tube 118 and mates with the receiver 144 when the handle lock 132 is in the locked position and is spaced-apart from the receiver 144 when the handle lock 132 is in the freed position. As shown in FIG. 14, the receiver 144 includes three slots 148, 149, and 150 that are formed in the handle joint 96 of the egress handle 84. As shown in FIG. 14, the first slot 148 is at about the twelve o'clock position and is associated with the handle 84 being in the second raised position. The second slot 149 is about about the eleven o'clock position and is associated with the handle 84 being in the first raised position. As also shown in FIG. 14, the third slot 150 is at about the seven o'clock position and is associated with the handle 84 being in the lowered position as shown in FIGS. 8 and 9 and viewed from a patient-left side of the hospital bed 310. The handle-lock actuator 146 is a solenoid that is coupled electrically to the bed controller 82. The caregiver or the patient uses one of the user interfaces 78, 80 to command the bed controller 82 to cause the solenoid to move the plunger 142 to the user desired position. While the handle-lock actuator 146 is shown as a solenoid, a mechanical actuator that uses an actuation force provided by a user may be used.

A caregiver commands the handle-lock actuator 146 to assume the freed position by moving the plunger 142 away from the receiver 144. After the plunger 142 has moved away from the receiver 144, the handle 84 may move between the lowered position and the raised positions. After the handle 84 is in the desired position, the caregiver again commands the handle-lock actuator 146 to assume the locked position by moving the plunger 142 back to mate with the receiver 144.

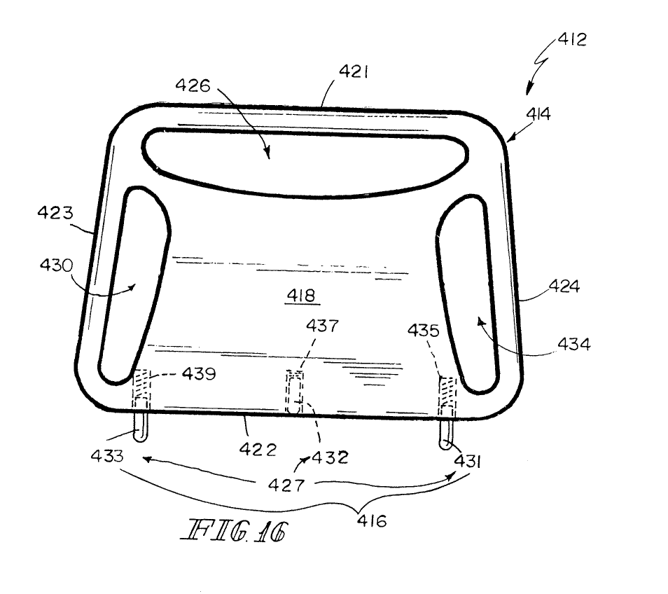

Finally, the grip lock 130 is moved from the locked position to the freed position. The grip lock 130 includes a plunger 152, a receiver 154, and a grip-lock actuator 156 as shown in FIG. 15. The plunger 152 lies in a space 158 formed in the handle mount 94 and mates with the receiver 154 when the grip lock 130 is in the locked position and is spaced-apart from the receiver 154 when the grip lock 130 is in the freed position. As shown in FIG. 15, the receiver 154 includes four slots 160, 162, 164, and 166 that are formed in the grip joint 90 of the egress handle 84. As shown in FIG. 15, the first slot 160 is at about the twelve o'clock position and is associated with the grip 88 being in the first grip position. As also shown in FIG. 15, the second slot 162 is at about the three o'clock position and is associated with the grip 88 being in a fourth grip position (not shown) that ma y be used during egress from the side of the hospital bed. The third slot 164 at about the six o'clock position and is associated with the grip being in the second grip position. The fourth slot 166 is at about the nine o'clock position and is associated with the grip 88 being in the third grip position. The grip-lock actuator 156 is a solenoid that is coupled electrically to the bed controller 82. The caregiver or the patient uses one of the user interfaces 78, 80 to command the bed controller 82 to cause the solenoid to move the plunger 152 to the user desired position. While the grip-lock actuator 156 is shown as a solenoid, a mechanical actuator that uses an actuation force provided by a user may be used.

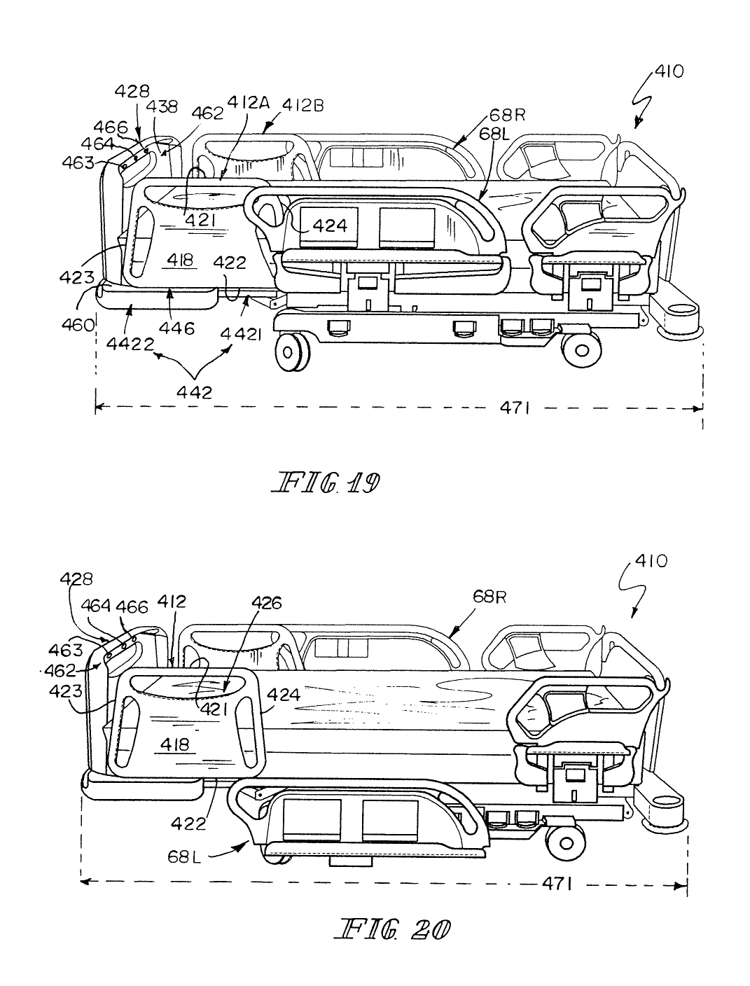

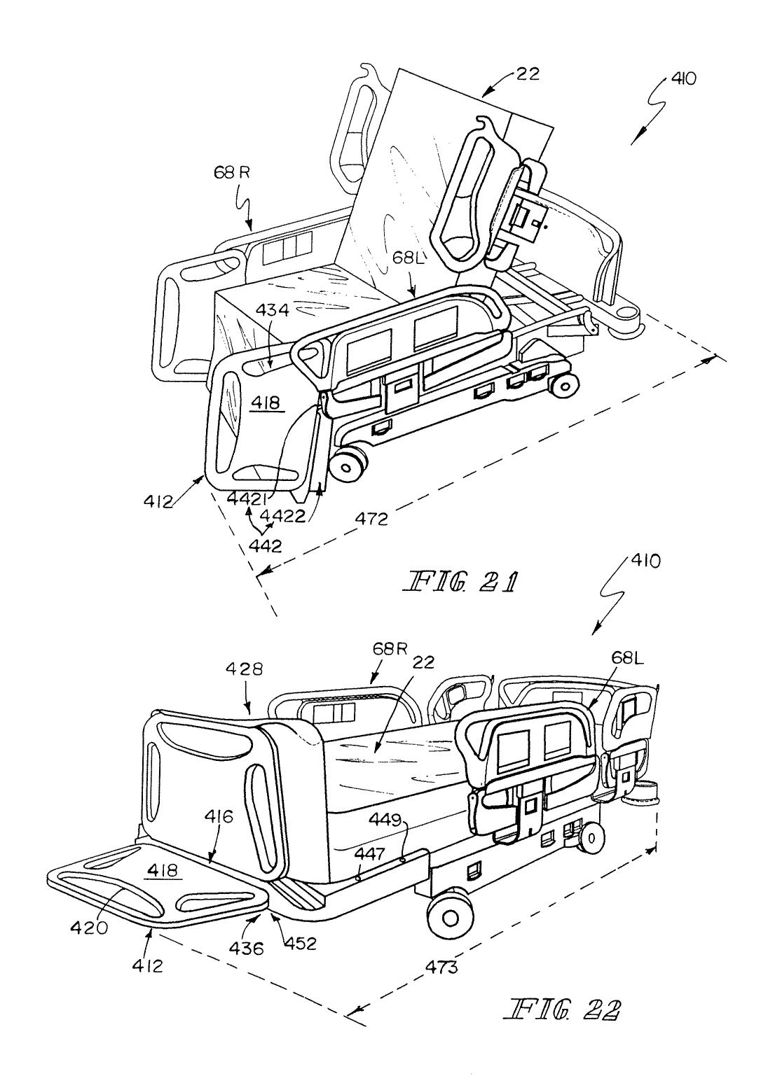

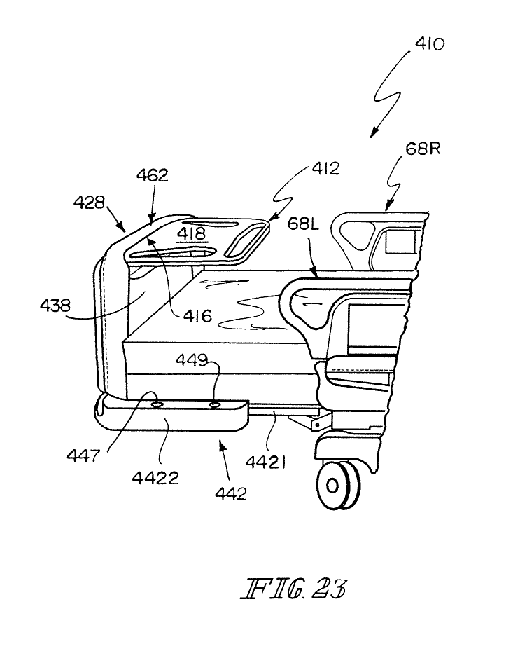

Another embodiment of a patient support apparatus 410 in accordance with the present disclosure is shown in FIGS. 16-23. The utility apparatuses 12, 212, and 312 are omitted from the hospital bed 410 and replaced with a utility apparatus 412. The utility apparatus 412 is configurable to assume a storage mode shown in FIG. 17, a gap-filling mode shown in FIG. 19, a side-egress mode shown in FIG. 20, a chair-egress mode shown in FIG. 21, a first-shelf mode shown in FIG. 22, and a second shelf-mode shown in FIG. 23.

As illustrated in FIG. 16, the utility apparatus 412 includes a panel 414 and a panel mount 416. The panel 414 includes a first side 418, an opposite second side 420, a first edge 421, a second edge 422 spaced-apart from and generally parallel to the first edge 421, a third edge 423 extending between the first and second edges 421, 422, and a fourth edge 424 spaced-apart from the third edge 423 and extending between the first and second edges 421, 422. The four edges 421, 422, 423, and 424 cooperate to define a perimeter of the panel 414 and bound the first and second sides 418, 420.

As illustrated in FIG. 16, the panel 414 is also formed to include first aperture 426, a second aperture 430, and a third aperture 434. The first aperture 426 opens completely through the panel 414 and extends along the first edge 421 between the second and third edges 423, 424. The second aperture 430 opens completely through the panel 414 and extends along the third edge 423 between the second and first edges 421, 422. The third aperture 434 opens completely through the panel 414 and extends along the fourth edge 424 between the first and second edges 421, 422. As an example, the apertures 426, 430, and 434 are used as hand grips in the various modes of use and as mounts for various objects to be hung from the apertures 426, 430, 434.

The panel mount 416 includes a series 427 of three pins 431, 432, 433 that are coupled to the panel 414 to move relative to the panel 414 between a retraced position and an extended position. When the pins 431, 432, 433 are in extended position, the pins 431, 432, 433 extend away from the second edge 422. As shown in FIG. 16, the three pins 431, 432, and 433 are spaced-apart equally from one another. First pin 431 is positioned to lie between second pin 432 and the fourth edge 424. Second pin 432 is positioned between first pin 431 and third pin 433. Third pin 433 is positioned between second pin 432 and third edge 423 of panel 414. As shown in FIG. 16, the pins 431 and 433 are in the extended positions and the second pin 432 is in the retracted position. When the pins 431, 432, 433 are in the retracted position, the pins 431, 432, 433 are positioned to lie in associated spaces 435, 437, and 439 formed in the panel 414. As an example, the pins 431, 432, 433 may be spring biased into the extended position.

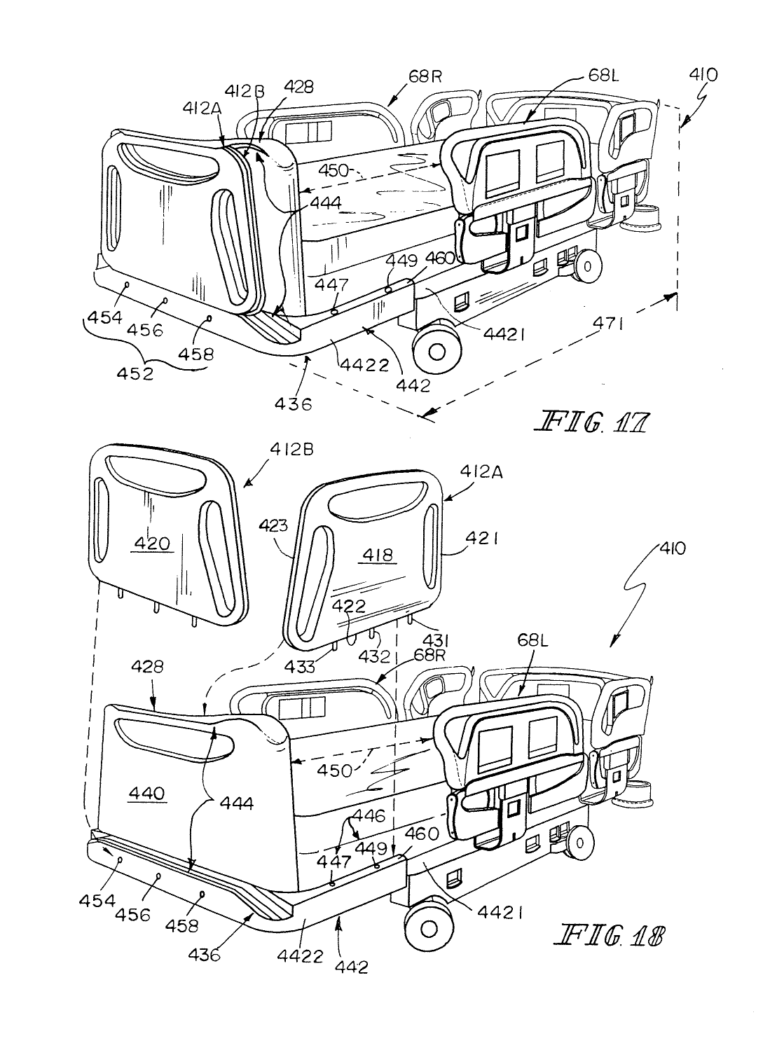

As shown in FIGS. 17 and 18, a pair of utility apparatuses 412A, 412B are shown in the storage mode. When the utility apparatuses 412A, 412B are in the storage mode, the hospital bed 10 has a first bed length 471 as shown in FIG. 17. A foot panel 428 included in the hospital bed 10 includes a first side 438 that is arranged to face toward the head panel 29 and an opposite second side 440. The second side 440 is formed to include a panel-receiving channel 444 that is configured to receive and retain the pair of utility apparatus 412A, 412B therein. As an example, the first side 418 of the utility apparatus 412A lies in confronting relation with the second side 440 of the foot panel 428 and the first side 418 of the utility apparatus 412B lies in confronting relation with the second side 420 of the utility apparatus 412A. The panel-receiving channel 444 is sized to cause the pins 431, 432, 433 to move from the extended position to the retracted position when the utility apparatus 412 slide into the panel-receiving channel 444. As a result, the utility apparatuses 412A, 412B may be removed from the foot panel 428 without removal of any equipment hanging from foot panel 428.

The utility apparatus 412 is arranged in the gap-filling mode by moving the utility apparatus 412 from the panel-receiving channel 444 and coupling the panel 414 to the foot section 442 as shown in FIG. 19. The utility apparatus 412 then extends away from a top surface 460 of the foot section 442 to fill a gap 450 as shown in FIG. 18. Gap 450 is formed between foot panel 428 and patient-left siderail assembly 68L. As shown in FIG. 19, second edge 422 of panel 414 lies in confronting relation with top surface 460 of foot section 442. Third edge 423 extends along a height of foot panel 428 and fourth edge 424 extends along a height of barrier panel 70 of siderail 68L. First edge 421 extends between third edge 423 and fourth edge 424 as illustrated in FIG. 19. When the utility apparatuses 412 is in the gap-filling mode, the hospital bed 10 remains having the first bed length 471 as shown in FIG. 19.

The utility apparatus 412 is coupled to the foot section 442 by panel mount 416 mating with a panel-mount receiver 446 formed in the foot section 442. As shown in FIG. 18, the foot section 442 includes a first portion 4421 and a second portion 4422 coupled to the first portion 4421 to move back and forth relative to the first portion 4421 to change the overall length of the foot section 442. The panel-mount receiver 446 is formed in the second portion 4422. The panel-mount receiver 446 includes a first pin aperture 447 aligned to below the third pin 434 and configured to receive the third pin 433 therein and a second pin aperture 449 aligned below the second pin 432 and configured to receive the second pin 432 therein.

As an example, the pins 431, 432 may be selectively locked in the pin apertures 445, 449 to block removal of the utility apparatus 412 from the foot section 442. A sensor (not shown) may also be coupled to the foot section 442 to sense the presence of the pins 431, 432 in the pin apertures 445, 449. The sensor may be coupled to the bed controller 82 to cause movement of the second portion 4422 of the foot section 442 to be blocked when the utility apparatus 412 is arranged in the gap mode. As a result, unintended damage to the utility apparatus 412 and the siderail 68L may be minimized.

The utility apparatus 412 is arranged in the side-egress mode as shown in FIG. 20. When the utility apparatuses 412 is in the side-egress mode, the hospital bed 10 remains having the first bed length 471 as shown in FIG. 20. The side-egress mode is achieved as a result of arranging the hospital bed 10 in the bed position, moving the foot siderail assemblies 68L, 68R to the lowered position, and moving the utility apparatus 412 from the storage mode of FIG. 17 to the position shown in FIG. 20. As an example, the utility apparatus 412, when in the side-egress mode, is in substantially the same position as when the utility apparatus 412 is in the gap-filling mode. In use, a patient sits at the side of the hospital bed 410 with their feet resting on the ground 99. The utility apparatus 412 is coupled to the foot section 442 as shown in FIG. 20, and the patient supports a portion of the patient's weight on the utility apparatus 412 by gripping the utility apparatus 412 through the second aperture 426.

The utility apparatus 412 is arranged in the chair-egress mode as shown FIG. 21. The chair-egress mode is achieved as a result of arranging the hospital bed 410 in the chair-egress position and moving the utility apparatus 412 from the storage mode of FIG. 17 to the position shown in FIG. 21. As an example, the utility apparatus 412, when in the chair-egress mode, is in substantially the same position as when the utility apparatus 412 is in the gap-filling mode and the side-egress mode.

As the hospital bed 410 moves from the bed position of FIGS. 17 and 18, the second portion 4422 of the foot section 442 retracts to shorten an overall length of the foot section 442 so that the foot section 442 does not run into the ground 99. The utility apparatus 412 is coupled to the second portion 4422 so that the utility apparatus 412 moves with the second portion 4422 of the seat section. Movement of the second portion 4422 relative to the first portion 4421 when the utility apparatus 412 is coupled to the foot section 442 is generally blocked by bed controller 82, but is permitted when moving to the chair-egress position. The retraction of the foot section 442 while the utility apparatus 412 is coupled to the foot section 442 acts to move the utility apparatus 412 and associated third aperture 434 upwardly so that a patient exiting the hospital bed 10 may grip the utility apparatus 412 more easily. When the utility apparatus 412 is in the chair-egress mode, the hospital bed 10 has a second bed length 473 as shown in FIG. 21. The second bed length 472 is less than the first bed length 471.

The utility apparatus 412 is arranged in the first-shelf mode as shown in FIG. 22. When the utility apparatus 412 is in the second-shelf mode, the hospital bed 10 has a third bed length 473 as shown in FIG. 22. The third bed length 473 is greater than the first bed length 471. The first-shelf mode is achieved as a result of arranging the hospital bed 410 in the bed position and moving the utility apparatus from the storage mode of FIG. 17 to the position illustrated in FIG. 22. The panel mount 416 of the utility apparatus is coupled to a first-shelf receiver 452 included in the foot panel 428 and includes a first pin aperture 454 aligned with the first pin 431 and configured to receive the first pin 431 therein, a second pin aperture 456 aligned with the second pin 432 and configured to receive the second pin 432 therein, and a third pin aperture 458 aligned with the third pin 433 and configured to receive the third pin 433 therein as shown in FIGS. 17 and 18.

When the utility apparatus 412 is in the first-shelf mode, the panel 414 of the utility apparatus is coupled to the foot panel 428 to extend in a longitudinal direction away from the head end 18 and the foot end 20 as shown in FIG. 22. The first side 418 of the panel 414 is arranged to face in the upward direction and the second side 420 is arranged to face toward the ground. The utility apparatus 412 is generally arranged to lie in generally coplanar relation with the foot section 442 of the deck 436. As an example, the utility apparatus 412 in the first-shelf mode may be used to store linens thereon for use at a later time or any other items suitable for storage thereon.

The utility apparatus 412 is arranged in the second-shelf mode as shown in FIG. 23. When the utility apparatuses 412 is in the first-shelf mode, the hospital bed 10 remains having the first bed length 471. The second-shelf mode is achieved as a result of arranging the hospital bed 410 in the bed position and moving the utility apparatus from the storage mode of FIG. 17 to the position illustrated in FIG. 23. The panel mount 416 of the utility apparatus is coupled to a second-shelf receiver 462 included in the foot panel 428. The second-shelf receiver 462 is formed in the first side 438 of foot panel 428 and includes a first pin aperture 463, a second pin aperture 464, and a third pin aperture 466 as shown in FIGS. 19 and 20. The first pin aperture 463 is aligned with the first pin 431 and configured to receive the first pin 431 therein, the second pin aperture 464 aligned with the second pin 432 and configured to receive the second pin 432 therein, and the third pin aperture 466 aligned with the third pin 433 and configured to receive the third pin 433 therein.

When the utility apparatus 412 is in the second-shelf mode, the panel 414 of the utility apparatus is coupled to the foot panel 428 to extend in a longitudinal direction away from the foot panel 428 toward the head end 18 as shown in FIG. 22. The first side 418 of the panel 414 is arranged to face in the upward direction and the second side 420 is arranged to face toward the mattress 16. The utility apparatus 412 lies generally parallel to and above the foot section 442. As an example, the utility apparatus 412 in the second-shelf mode may be used to store supplies or equipment for use during transport.

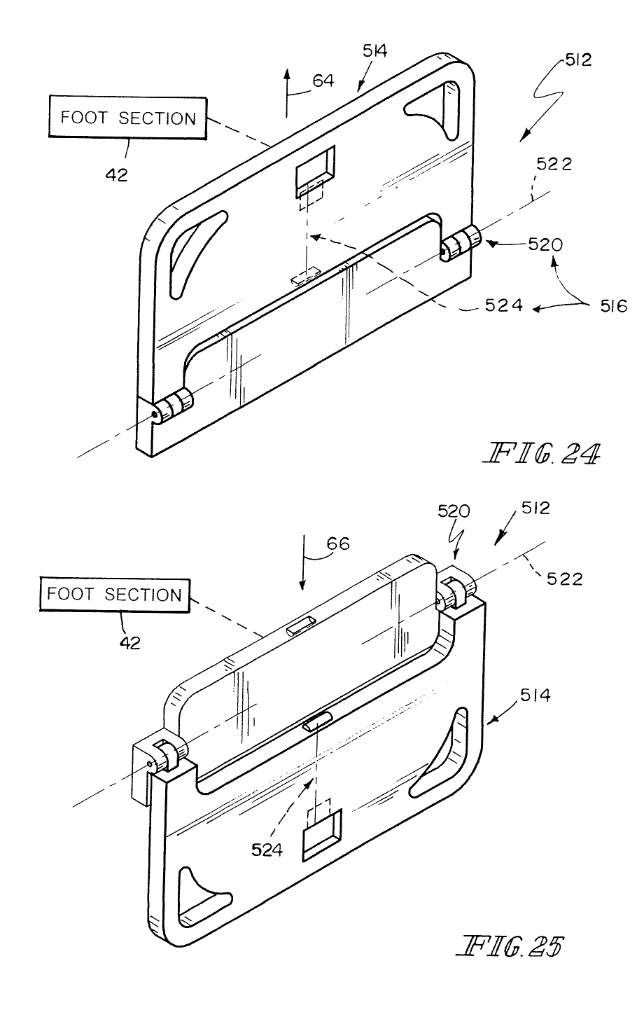

Another embodiment of a utility apparatus 512 is shown in FIGS. 24 and 25. The utility apparatuses 12, 212, 312, and 412 are omitted from the hospital bed 10, 210, and 310, and replaced with the utility apparatus 512. The utility apparatus 512 includes the panel 514 and a panel mount 516. The utility apparatus 512 is movable between a raised position illustrated in FIG. 24 and a lowered position illustrated in FIG. 25. The panel mount 516 includes a panel pivot 520 and a panel lock 524. The panel pivot 520 interconnects the panel 414 to the foot section 42 of the deck 36 to cause the panel 414 to rotate about a panel rotation axis 522 as shown in FIGS. 24 and 25.

As shown in FIG. 24, the utility apparatus 512, when in the raised position, extends in the upward direction 64 away from the foot section 42 into a gap. The gap is arranged to extend between the foot panel 28 and the siderail assembly 68L. The utility apparatus 512, when in the lowered position, extends in the downward direction 66 away from the foot section 42 toward the ground.

When the hospital bed 510 is in the bed position, the siderail assembly 68L is in the raised position, and the utility apparatus 512 is in the raised position, a gap-filling mode of the utility apparatus 512 is established. When the hospital bed 510 is in the bed position, the siderail assembly 68L is in the lowered position, and the utility apparatus 512 in the raised position, a side-egress mode of the utility apparatus 512 is established. When the hospital bed 510 is in the chair-egress position and the siderail is in the raised position, a chair-egress mode of the utility apparatus 512 is established.

The panel pivot 520 is coupled to a second portion 4422 of foot section 42 and is configured to move with the second portion 4422 relative to a first portion 4421 of the foot section 42. As discussed previously with respect to utility apparatus 412, the panel 414 moves with the second portion 4422 so that the panel 514 is at an appropriate height for use by a patient during egress from the hospital bed 510 when the foot section 42 retracts.

A sensor (not shown) may also be coupled to the foot section 42 to sense whether the utility apparatus is in the raised or the lowered position. The sensor may be coupled to the bed controller 82 to cause movement of the second portion 4422 of the foot section 42 to be blocked when the utility apparatus 512 is arranged in the gap-filling mode. As a result, unintended damage to the utility apparatus 512 and the siderail 68L may be minimized. Similarly, the bed controller 82 may block movement of the hospital bed 510 from the bed position to the chair-egress position when the utility apparatus 512 is in the lowered position so that damage to the utility apparatus 512 is minimizes.

Illustrative beds 10, 210, 310, 410, and 510 are so-called chair egress beds, in that they are movable between a bed position, as shown in FIG. 1, and a chair-egress position as shown in FIG. 2. However the teachings of this disclosure are applicable to all types of hospital beds, including those that are incapable of achieving a chair-egress position. Some hospital beds are only able to move into a chair-like position, sometimes referred to by those in the art as a “cardiac chair position,” and this disclosure is equally applicable to those types of beds. Furthermore, the teachings of this disclosure are applicable to other types of patient support apparatuses such as stretchers, motorized chairs, operating room (OR) tables, specialty surgical tables such as orthopedic surgery tables, examination tables, and the like.

Although certain illustrative embodiments have been described in detail above, variations and modifications exist within the scope and spirit of this disclosure as described and as defined in the following claims.

1. A patient support apparatus comprising
a base,
a frame coupled to the base, the frame being movable relative to the base,
a deck supported by the frame and movable relative to the frame between a horizontal position and an articulated position, the deck including at least a head section, a foot section spaced-apart from the head section, and a seat section positioned between the head section and the foot section, and the foot section being pivotable about a first lateral pivot axis relative to the frame, and
an egress unit coupled to the foot section of the deck and movable between a storage position in which the egress unit is positioned to lie below a top surface of the foot section and a use position in which the egress unit extends in an upward direction away from the top surface of the foot section to support a portion of a patient's weight so that a patient can egress from the patient support apparatus.

2. The patient support apparatus of claim 1, wherein the egress unit includes a handle coupled to the foot section of the deck to move about a lateral pivot axis between a lowered position in which the handle is positioned to lie below the top surface of the foot section and a raised position in which the handle extends above the top surface of the foot section.

3. The patient support apparatus of claim 2, wherein the foot section includes a head edge, a foot edge spaced-apart from and generally parallel to the head edge, and a first longitudinal side arranged to extend between and to interconnect the head and foot edges of the foot section, and the handle is coupled to the first longitudinal side of the foot section to extend away from the foot section in a lateral direction.

4. The patient support apparatus of claim 2, wherein the foot section includes a head edge, a foot edge spaced-apart from and generally parallel to the head edge, and a recess formed in the foot section, the recess being configured to receive the handle when the handle is in the lowered position to cause a maximum width of the foot section to be about equal to a first foot-section width defined by the foot edge.

5. The patient support apparatus of claim 2, wherein the foot section includes the top surface arranged to face in the upward direction when the patient support apparatus is in the horizontal position and an opposite bottom surface arranged to face in an opposite downward direction when the patient support apparatus is in the horizontal position, the handle is coupled to the bottom surface and is arranged to extend in the downward direction when the handle is in the lowered position.

6. The patient support apparatus of claim 1, wherein the egress unit includes a handle and a slide assembly arranged to lie between and to interconnect the handle to the foot section of the deck, the slide assembly is movable between a retracted position in which the handle is positioned to lie adjacent to the foot section and an extended position in which the handle is positioned to lie in spaced-apart relation to the foot section.

7. The patient support apparatus of claim 6, wherein the slide assembly translates back and forth about a lateral pivot axis and the handle is movable relative to the slide assembly about the lateral pivot axis between a lowered position in which the handle is positioned to lie below a plane defined by the top surface of the foot section and a raised position in which the handle has rotated about the lateral pivot axis to extend away from the top surface of the foot section.

8. The patient support apparatus of claim 7, wherein the handle includes a grip adapted to be grasped by a patient during egress from the patient support apparatus and an arm interconnecting the grip to the slide assembly to cause the grip and the arm to rotate about lateral pivot axis away from the foot section toward the seat section to assume the raised position.

9. The patient support apparatus of claim 8, wherein the handle further includes a grip joint arranged to lie between and to interconnect the grip to the arm to cause the grip to pivot about a handle axis between a first position in which the grip extends away from the handle axis toward a foot end of the patient support apparatus, a second position in which the grip extends away from the handle axis toward an opposite head end of the patient support apparatus, and a third position in which the grip extends away from the handle axis toward a longitudinal axis of the patient support apparatus.

10. The patient support apparatus of claim 9, wherein the slide assembly includes a slide tube coupled to the arm to move therewith and a slide-tube receiver coupled to the foot section to move therewith, the slide-tube receiver is configured to support the slide tube therein for back-and-forth movement along the lateral pivot axis between the extended and retracted positions.

11. The patient support apparatus of claim 10, wherein the egress unit further includes a position controller including a grip lock configured to block selectively movement of the grip about the handle axis relative to the arm, a handle lock configured to block selectively movement of the handle about the lateral pivot axis relative to the slide tube, and a slide lock configured to selectively block movement of the slide assembly about the lateral pivot axis relative to the foot section.

12. A patient support apparatus comprising
a base,
a frame coupled to the base, the frame being movable relative to the base,
a deck supported by the frame and movable relative to the frame between a bed position and a chair-egress position, the deck including at least a head section, a foot section spaced-apart from the head section, and a seat section positioned between the head and foot sections, the seat section including a foot edge, an oppositely spaced-apart head edge, a first longitudinal edge arranged to extend between the foot edge and the head edge, and an opposite second longitudinal edge arranged in spaced-apart generally parallel relation to the first longitudinal edge, and the foot section being pivotable about a first lateral pivot axis relative to the frame, and
a handle coupled to the foot section to move about a pivot axis in a first direction relative to the foot section from a lowered position in which the handle is generally parallel with and adjacent to the first longitudinal side of the foot section to a raised position in which the handle extends in an upward direction away from the foot section.

13. The patient support apparatus of claim 12, further comprising a slide assembly including a slide-tube receiver coupled to the foot section in a fixed position and a slide tube coupled to the slide-tube receiver to translate back and forth along the pivot axis relative to the slide-tube receiver, the slide assembly being in a retracted position when the slide tube lies between the first and second longitudinal sides of the foot section, and the slide assembly being in an extended position when the slide tube has translated along the pivot axis away from the first and second longitudinal edges of the foot section.

14. The patient support apparatus of claim 13, further comprising a slide lock coupled to the foot section and selectively movable from a locked position wherein the slide lock interconnects the slide tube to the slide-tube receiver to block movement of the slide tube relative to the slide-tube receiver to a freed position wherein the slide tube is freed to move relative to the slide-tube receiver.

15. The patient support apparatus of claim 12, further comprising a handle lock coupled to the foot section and selectively movable from a locked position wherein the wherein the handle lock interconnects the handle to the foot section to block movement of the handle about the pivot axis relative to the foot section to a freed position wherein the handle is freed to move about the pivot axis relative to the foot section.

16. The patient support apparatus of claim 12, wherein the handle includes a grip adapted to be grasped by a patient during egress from the patient support apparatus, a mount coupled on a first end to the grip, and a handle joint arranged to interconnect an opposite second end of the mount to the foot section to cause the mount and the grip to rotate about the pivot axis in a direction away from the foot section toward the seat section to assume the raised position.

17. The patient support apparatus of claim 16, wherein the handle further includes a grip mount arranged to lie between and to interconnect the grip and the mount to cause the grip to rotate about a handle axis relative to the mount.

18. The patient support apparatus of claim 17, wherein the handle axis intersects the pivot axis about a right angle.

19. The patient support apparatus of claim 18, wherein the pivot axis is spaced-apart from and generally parallel to the first lateral pivot axis.

20. A patient support apparatus comprising
a base,
a frame coupled to the base to move relative to the base,
a deck supported by the frame to move relative to the frame between a horizontal position and an articulated position, the deck including a head section, a foot section spaced-apart from the head section, and a seat section positioned between the head section and the foot section, the foot section being pivotable about a first lateral pivot axis relative to the frame and the foot section including a top surface, an opposite bottom surface, a first longitudinal side, a second longitudinal side spaced-apart from the first longitudinal side, a head side extending between and interconnecting the longitudinal sides, and a foot side spaced-apart from and parallel to the head side,
a siderail assembly including a linkage and a barrier, the linkage being coupled to the frame below the seat section and between the head and the foot sections, the barrier being coupled to the linkage to move relative to the deck between a raised position wherein the barrier is substantially above the seat section of the deck and a lowered position wherein the barrier is substantially below the seat section of the deck,
a head panel being coupled to the frame at a head end of the frame to move therewith,
a foot panel being selectively coupled to the foot section of the deck to extend in an upward direction away from the foot section, and
a utility apparatus being configurable to provide one of a storage mode in which the utility apparatus is coupled to the foot panel to lie outside a perimeter of the foot section and a first-use mode in which the utility apparatus is coupled to the foot section of the deck along the first longitudinal side to extend into a foot-section gap defined between the foot panel and the siderail assembly.
